(19) United States
(12) Patent Application Publication
(10) Pub. No.: US 2013/0342192 A1
(43) Pub. Date: Dec. 26, 2013

(54) ANGLE SENSOR

(71) Applicants: Ryojiro KANEMITSU, Obu-shi (JP); Shinya SUZUKI, Nagoya-shi (JP)

(72) Inventors: Ryojiro KANEMITSU, Obu-shi (JP); Shinya SUZUKI, Nagoya-shi (JP)

(73) Assignee: AISAN KOGYO KABUSHIKI KAISHA, Obu-shi (JP)

(21) Appl. No.: 13/914,994

(22) Filed: Jun. 11, 2013

(30) Foreign Application Priority Data
Jun. 26, 2012 (JP) 2012-142753

(51) Int. Cl. G01B 7/30

(52) U.S. Cl. CPC G01B 7/30
USPC 324/207.17

(57) ABSTRACT

An angle sensor includes a sensor rotor formed with a planar coil and a sensor stator placed to face the sensor rotor with a gap therefrom and formed with a planar coil. The planar coil of the sensor stator includes an SIN phase coil and a COS phase coil each having an annular ring shape, and a rotary transformer coil placed radially inside of a region where both the coils are provided. The rotary transformer coil includes two connecting wires to connect to an external circuit, the two connecting wires being arranged to extend across the coils. The two connecting wires are arranged one above the other in their portions that extend across the coils while an insulating film is interposed between the connecting wires.

### CROSS-REFERENCE TO RELATED APPLICATIONS

This application is based upon and claims the benefit of priority from the prior Japanese Patent Application No. 2012-142753 filed on Jun. 26, 2012, the entire contents of which are incorporated herein by reference.

### BACKGROUND OF THE INVENTION

1. Field of the Invention

The present invention relates to an angle sensor provided to an output shaft of a motor or an engine to detect rotation angle thereof.

2. Related Art

Conventionally, there is known as the above type of technique, a rotary transformer type resolver disclosed in Japanese patent application publication No. 8(1996)-136211. This resolver includes a fixed side core and a rotary side core placed to face the fixed side core with a gap therefrom and be rotatable integrally with a shaft. The fixed side core is provided with a primary winding and the rotary side core is provided with a secondary winding. These primary and secondary windings constitute a rotary transformer part. This rotary transformer part is provided with an excitation winding and the fixed side core is provided with a detection winding. Those excitation winding and detection winding constitute a signal generation part. On a surface of the fixed side core facing a surface of the rotary side core, a fixed side sheet coil made of the integrally formed primary winding and detection winding is fixed. On the surface of the rotary core, a rotary side sheet coil made of the integrally formed secondary winding and excitation winding is fixed. Herein, two leads of each of the primary winding and the secondary winding constituting the rotary transformer part are arranged in different positions on sheet coil forming surfaces.

### SUMMARY OF INVENTION

### Problems to be Solved by the Invention

However, in the resolver disclosed in JP 8(1996)-136211A, the two leads of each of the primary winding and the secondary winding constituting the rotary transformer part are located in different positions on the sheet coil forming surfaces. Accordingly, a pseudo closed circuit may be generated in a part where the two leads extend across or traverse an SIN phase coil and a COS phase coil constituting the excitation winding and the detection winding. As a result thereof, it was newly found that the SIN phase coil and the COS phase coil are subjected to interaction with the two leads, that is, these phase coils are influenced by magnetic linkage, causing a detection error to be generated in the resolver. For instance, the following is found: when an AC signal is supplied to the rotary transformer part, a change in magnetic field occurs in the closed circuit part of the two leads, and such a magnetic field change generates unnecessary electromotive force (noise) in the SIN phase coil and the COS phase coil, and thus detection accuracy of the resolver is deteriorated.

The present invention has been made in view of the circumstances and has a purpose to provide an angle sensor capable of reducing the influence of magnetic linkage of a SIN phase coil and a COS phase coil of a sensor stator and two connecting wires of a rotary transformer coil, thereby achieving reduction of detection errors.

### Solution to Problem

To achieve the above purpose, one aspect of the invention provides an angle sensor including: a sensor rotor having a main surface formed with a planar coil, the sensor rotor being attached to a rotary shaft and; and a sensor stator having a main surface formed with a planar coil, the sensor stator being placed so that its main surface faces the main surface of the sensor rotor with a gap therefrom, the planar coil of the sensor stator including an SIN phase coil and a COS phase coil each having an annular ring shape, and a rotary transformer coil placed radially inside of a region where the SIN phase coil and the COS phase coil are provided, the rotary transformer coil including two connecting wires to be connected to an external circuit, the two connecting wires being placed to extend across the SIN phase coil and the COS phase coil, wherein the two connecting wires of the rotary transformer coil are placed so that at least portions extending across the SIN phase coil and the COS phase coil overlap one above the other.

### Advantageous Effects of Invention

According to the present invention, it is possible to reduce the influence of magnetic linkage of a SIN phase coil and a COS phase coil of a sensor stator and two connecting wires of a rotary transformer coil and achieve reduction of detection errors of the angle sensor.

### BRIEF DESCRIPTION OF THE DRAWINGS

FIG. 1 is a front sectional view showing an angle sensor and a motor in which the angle sensor is mounted in an embodiment;

FIG. 2 is a plan view showing a sensor rotor of an angle sensor in the embodiment;

FIG. 3 is a plan view showing a sensor stator of the angle sensor in the embodiment;

FIG. 4 is a plan view showing only a planar coil of the sensor stator in the embodiment;

FIG. 5 is an enlarged sectional view of a middle portion of a connecting wire shown in FIG. 4, taken along a vertical direction in the embodiment;

FIG. 6 is a schematic diagram showing a relationship between two connecting wires, their magnetic fields, and excitation coil patterns in the embodiment;

FIG. 7 is a plan view showing a planar coil of a sensor stator in a comparative example of the embodiment;

FIG. 8 is a schematic diagram showing a relationship between two connecting wires, their magnetic fields, and excitation coil patterns in the comparative example of the. embodiment;

FIG. 9 is a graph showing differences in error between the embodiment and the comparative example;

FIG. 10 is a graph showing a relationship between first-order error, second-order error, fourth-order error, and overall error in the embodiment; and

FIG. 11 is a plan view showing only a planar coil of a sensor stator in another embodiment.

### DESCRIPTION OF EMBODIMENTS

A detailed description of an embodiment of an angle sensor embodying the present invention will now be given referring to the accompanying drawings.

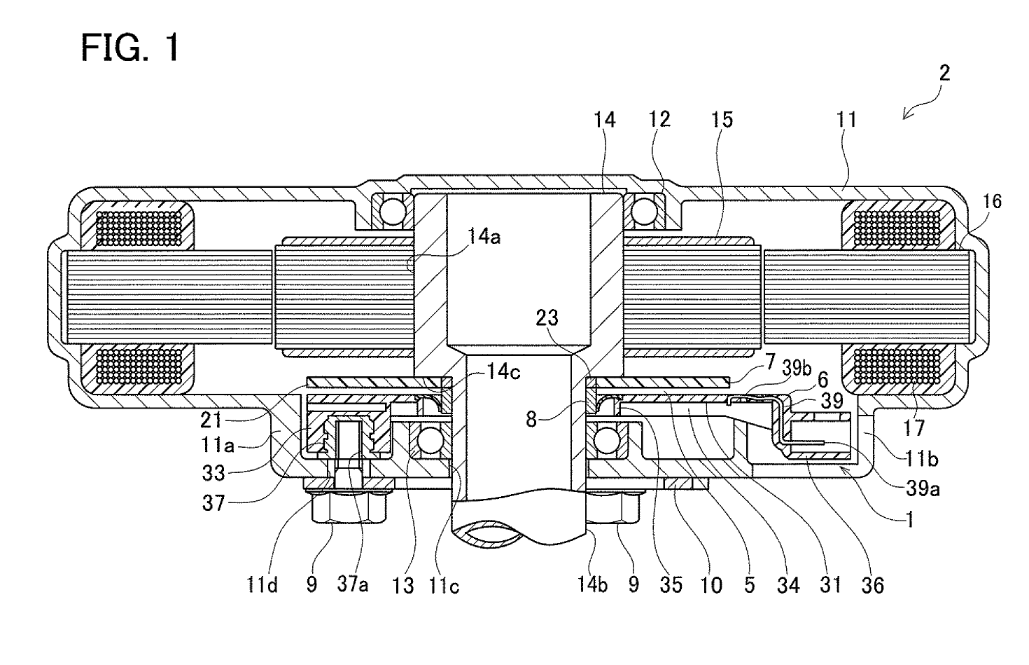

FIG. 1 is a front sectional view of an angle sensor 1 in this embodiment, and a motor 2 in which the angle sensor 1 is mounted. Hereinafter, the orientation of FIG. 1 is considered as a front view for convenience. The motor 2 includes a motor housing 11 having a substantially annular disk-like outer shape, a rotary shaft 14 partially housed in the motor housing 11 and rotatably supported with bearings 12 and 13 in the inside center of the housing 11, a motor rotor 15 fixed on the outer periphery of the rotary shaft 14 inside the motor housing 11, and a motor stator 16 fixed to the inside of the motor housing 11 to surround the motor rotor 15 with a gap therefrom. The motor stator 16 is provided with a coil 17.

In FIG. 1, the motor housing 11 is integrally formed, at its lower side, with a housing part 11a in which the angle sensor 1 is accommodated. This housing part 11a includes a nearly annular-ring-shaped peripheral wall substantially centered on the rotary shaft 14 and the bearing 13. A part of the peripheral wall of the housing part 11a is formed with a communication hole 11b communicating with the outside.

As shown in FIG. 1, the rotary shaft 14 of the motor 2 has a nearly cylindrical shape including a large-diameter portion 14a, a small-diameter portion 14b, and a stepped portion 14c located at the boundary between the large-diameter portion 14a and the small-diameter portion 14b. The large-diameter portion 14a is supported by the bearing 12 on one side, and the motor rotor 15 is fixed on the outer periphery of the large-diameter portion 14a. The small-diameter portion 14b is supported by the bearing 13 on the other side and extends with a distal end portion protruding out through a shaft hole 11e formed in a bottom wall of the housing part 11a.

As shown in FIG. 1, the angle sensor 1 is provided with a sensor stator 6 and a sensor rotor 7. The sensor rotor 7 is press-fit on the outer periphery of the small-diameter portion 14b of the rotary shaft 14 inside the motor housing 11 and retained by a ring-shaped stopper 8. The sensor stator 6 is placed inside the housing part 11a of the motor housing 11 and substantially centered on the rotary shaft 14 to face the sensor rotor 7, and fixed from outside of the motor housing 11 with a plurality of bolts 9. The bottom wall of the housing part 11a is formed with a plurality of long holes 11d through which the bolts 9 are inserted. In the present embodiment, a nearly annular-ring-shaped connecting member 10 is interposed between the bolts 9 and the housing part 11a.

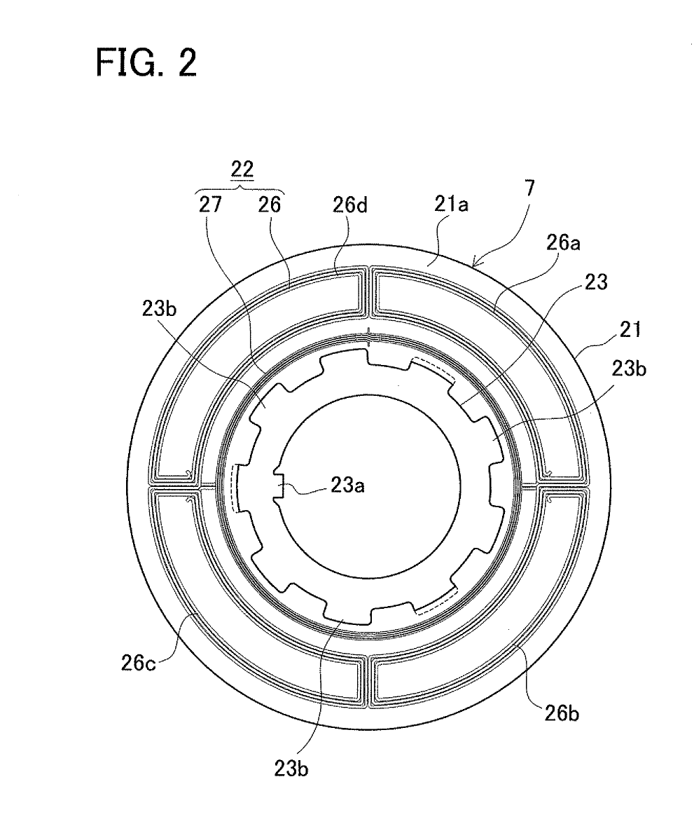

FIG. 2 is a plan view showing the sensor rotor 7 of the angle sensor 1 in the present embodiment. As shown in FIGS. 1 and 2, the sensor rotor 7 includes a flat annular disk-shaped rotor substrate 21 made of resin, a planar coil 22 placed on a main surface 21a of the rotor substrate 21, and an annular metal member 23 having a nearly annular ring shape integrally provided on an inner circumferential side of the rotor substrate 21. The annular metal member 23 is placed in contact with the rotary shaft 14 to mount and fix the sensor rotor 7 on the outer periphery of the rotary shaft 14.

The rotor substrate 21 is made of for example PPS resin. The annular metal member 23 is made of for example stainless steel (SUS in HS). The planar coil 22 is formed on the main surface 21a of the rotor substrate 21 by inkjet printing and others, and an insulating film or coating (not shown) is formed on the planar coil 22. As shown in FIG. 2, the annular metal member 23 includes a single protrusion 23a integrally formed with and radially inwardly protruded from the inner periphery of the annular metal member 23 and a plurality of protrusions 23b integrally formed with and radially outwardly protruded from the outer periphery of the annular metal member 23. The protrusions 23b are circumferentially arranged at equal intervals in a radial pattern. Outer peripheral portions of the annular metal member 23 including the protrusions 23b are insert-molded in the rotor substrate 21.

As shown in FIG. 1, the sensor rotor 7 is placed so that the main surface 21a (a lower surface in FIG. 1) of the rotor substrate 21 faces a main surface (an upper surface in FIG. 1) of the sensor stator 6 with a gap 5 therefrom. The sensor rotor 7 is mounted on the outer periphery of the small-diameter portion 14b of the rotary shaft 14. Herein, while the inner periphery of the annular metal member 23 is press fitted on the small-diameter portion 14b of the rotary shaft 14 and positioned in place by the stepped portion 14c, the sensor rotor 7 is held against slippage by the ring-shaped stopper 8. In addition, the protrusion 23a of the annular metal member 23 is engaged in a key groove (not shown) formed in the small-diameter portion 14b, thereby holding the sensor rotor 7 against rotation with respect to the rotary shaft 14. In this manner, the sensor rotor 7 is fixed to be rotatable together with the rotary shaft 14.

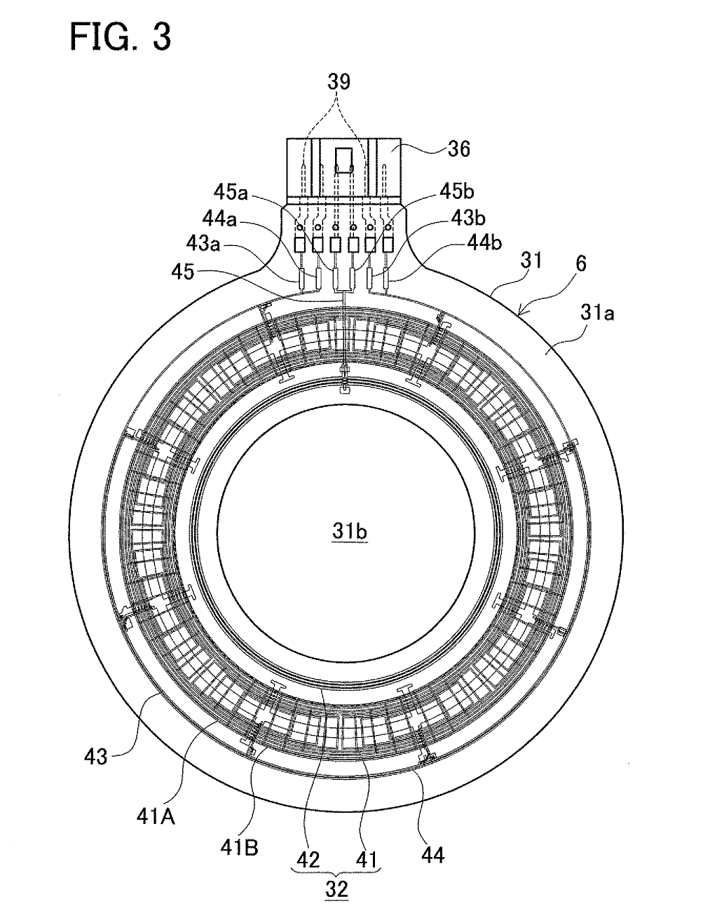

FIG. 3 is a plan view showing the sensor stator 6 of the angle sensor 1 in the present embodiment. As shown in FIGS. 1 and 3, the sensor stator 6 includes a nearly flat annular disk-shaped stator substrate 31 made of resin, a planar coil 32 placed on a main surface 31a of the stator substrate 31, a plurality of fixing protrusions 33 provided on a rear surface of the stator substrate 31, an outer circumferential rib 34 formed along an outer circumferential edge on the rear surface of the stator substrate 31 and to extend in an axial direction, a through hole 3 lb formed in the center portion of the stator substrate 31 to allow the rotary shaft 14 to pass therethrough, an inner circumferential rib 35 formed along an inner circumferential edge of the through hole 31b on the rear side of the stator substrate 31, the rib 35 being extended in the axial direction, and a single connector part 36 protruding sideways (in a horizontal direction) from the stator substrate 31. The outer circumferential rib 34 and the fixing protrusions 33 are formed continuously and integrally. As shown in FIG. 3, the planar coil 32 placed on the main surface 31a of the stator substrate 31 is formed by inkjet printing and others, and an insulating film or coating (not shown) is formed on the planar coil 32.

As shown in FIG. 1, each of the fixing protrusions 33 (only one of them is illustrated in FIG. 1) has a columnar shape. In the present embodiment, the protrusions 33 are arranged on the rear surface of the stator substrate 31 and at equal angular intervals along the outer circumference of the stator substrate 31. Each of the protrusions 33 is provided with a metal bush 37 having a screw hole 37a. The bushes 37 are individually insert-molded in the protrusions 33. In each metal bush 37, the bolt 9 is screwed to fix the sensor stator 6 to the motor housing 11.

As shown in FIG. 1, a plurality of metal terminals 39 are insert-molded in the connector part 36. Each of the terminals 39 is bent at a right angle and has a first end portion 39a placed in the connector part 36 and a second end portion 39b placed in the stator substrate 31. The second end portions 39b placed in the stator substrate 31 are connected to coil wires constituting the planar coil 32.

The details of the planar coil 22 of the sensor rotor 7 and the planar coil 32 of the sensor stator 6 are explained below. As shown in FIG. 2, the planar coil 22 of the sensor rotor 7 includes an excitation coil pattern 26 and a rotary transformer coil pattern 27. The excitation coil pattern 26 and the rotary transformer coil pattern 27 are formed in the same layer. The excitation coil pattern 26 consists of four coil sections 26a, 26b, 26c, and 26d arranged in a circumferential direction into a ring form. The rotary transformer coil pattern 27 is placed radially inside of a region in which the excitation coil pattern 26 is provided in the ring form. On the layer of the excitation coil pattern 26 and the rotary transformer coil pattern 27, a nearly annular-ring-shaped insulating film or coating (not shown) is formed.

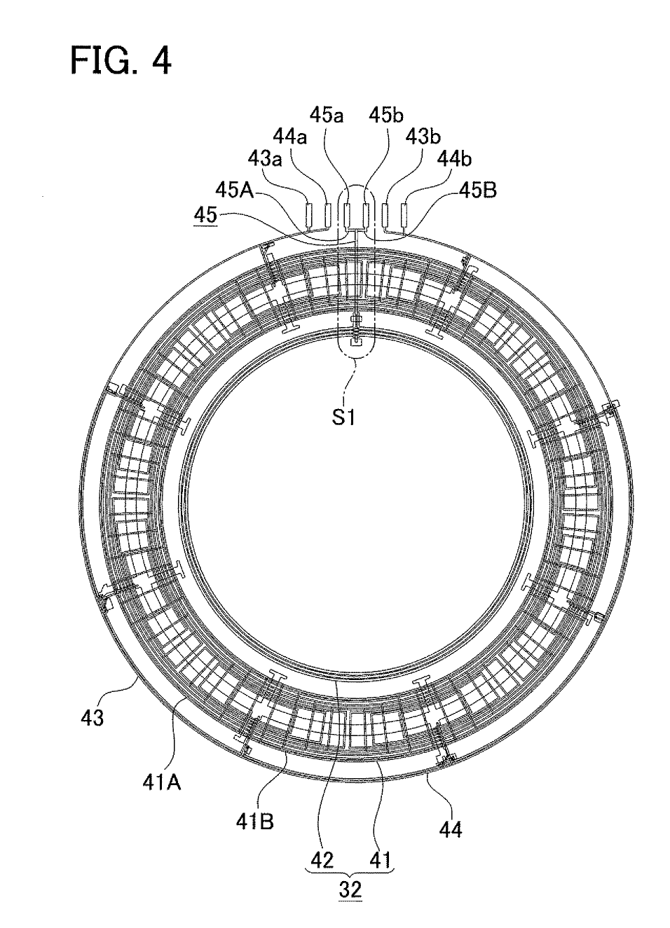

FIG. 4 is a plan view showing only the planar coil 32 of the sensor stator 6. As shown in FIGS. 3 and 4, this planar coil 32 includes a detection coil pattern 41 and a rotary transformer coil pattern 42. These coil patterns 41 and 42 are formed in the same layer. The detection coil pattern 41 includes an SIN phase coil pattern 41 A and a COS phase coil pattern 41B. These coil patterns 41A and 41B are placed respectively in an annular ring shape and arranged with a phase shift of 90° in electrical angle from each other in a circumferential direction. The rotary transformer coil pattern 42 is placed radially inside of a region in which the detection coil pattern 41 is provided. On the detection coil pattern 41 and the rotary transformer coil pattern 42, a nearly annular-ring-shaped insulating film or coating (not shown) is formed. The SIN phase coil pattern 41A includes a connecting wire 43 arranged around the outer circumference of the coil pattern 41A. Ends of the connecting wire 43 are provided with a pair of terminals 43a and 43b. Similarly, the COS phase coil pattern 41B includes a connecting wire 44 arranged around the outer circumference of the coil pattern 41B. Ends of the connecting wire 44 are provided with a pair of terminals 44a and 44b. Furthermore, the rotary transformer coil pattern 42 also includes a connecting wire 45 having a pair of terminals 45a and 45b at ends. The terminals 43a, 43b, 44a, 44b, 45a, and 45b of the connecting wires 43, 44, and 45 are connected one by one to the terminals 39 provided in the connector part 36 and hence to an external circuit.

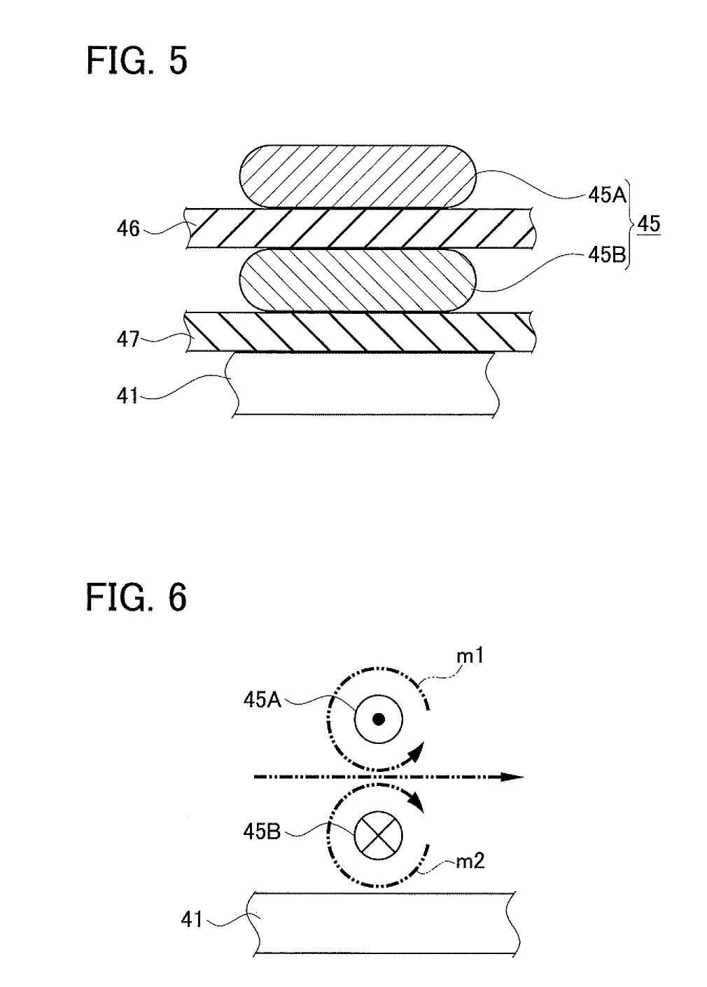

As shown in an elliptic area SI surrounded by a chain line in FIG. 4, the connecting wire 45 of the rotary transformer coil pattern 42 consists of two connecting wires 45A and 45B. These two connecting wires 45A and 45B are arranged to extend across or traverse the detection coil pattern 41 (the SIN phase coil pattern 41A and the COS phase coil pattern 41B). FIG. 5 is an enlarged sectional view of a middle portion of the connecting wire 45 shown in FIG. 4, taken along a vertical direction. As shown in FIG. 5, the two connecting wires 45A and 45B are placed to overlap one above the other in a part extending across or traversing the detection coil pattern 41. The two connecting wires 45A and 45B are placed to overlap one above the other while an insulating film 46 is interposed therebetween. Similarly, an insulating film 47 is provided between the connecting wire 45 and the detection coil pattern 41. Herein, the term “one above the other” of the expression “placed to overlap one above the other” represents a vertical direction to a surface on which the SIN phase coil pattern 41A and the COS phase coil pattern 41B are formed.

A brief explanation of the operations of the aforementioned angle sensor 1 is given below. During operation of the motor 2, when an excitation signal is generated in a predetermined excitation signal generating circuit, the excitation signal is supplied to the excitation coil 26 of the sensor rotor 7 via the connecting wires 45A and 45B and the rotary transformer coil pattern 42 of the sensor stator 6, and the rotary transformer coil pattern 27 of the sensor rotor 7. The current of this excitation signal generates a magnetic flux in the excitation coil 26, thereby generating electromotive force (a SIN signal and a COS signal) in the SIN phase coil pattern 41A and the COS phase coil pattern 41B of the sensor stator 6. Then, amplitude variation in the electromotive force (SIN signal) generated in the SIN phase coil pattern 41A and amplitude variation in the electromotive force (COS signal) generated in the COS phase coil pattern 41B are detected by a predetermined detection circuit. Further, those signals after detection are analyzed by a predetermined arithmetic circuit to calculate the rotation position of the sensor rotor 7. With the angle sensor 1 configured as above, the rotation angle of the rotary shaft 14 can be detected.

According to the angle sensor 1 of the present embodiment explained above, in the sensor stator 6, the two connecting wires 45A and 45B of the rotary transformer coil pattern 42 are placed to overlap one above the other in the part extending across or traversing the detection coil pattern 41 (the SIN phase coil pattern 41A and the COS phase coil pattern 41B). Herein, as shown in FIG. 6, the currents flowing in the two connecting wires 45A and 45B are opposite in direction, so that magnetic fields m1 and m2 generated respectively around the two connecting wires 45A and 45B are opposite in direction from each other. Accordingly, the magnetic fields m1 and m2 reinforce each other between the two connecting wires 45A and 45B. In addition, the reinforcing direction of the magnetic fields m1 and m2 is parallel to the detection coil pattern 41 (the SIN phase coil pattern 41A and the COS phase coil pattern 41B) as shown in FIG. 6. Therefore, the magnetic linkage has less influence on the detection coil pattern 41. This can reduce detection errors of the angle sensor 1. FIG. 6 is a schematic diagram showing a relationship between the two connecting wires 45A and 45B, their magnetic fields m1 and m2, and the detection coil pattern 41.

In the present embodiment, furthermore, since the two connecting wires 45A and 45B are placed to overlap one above the other while the insulating film 46 is interposed therebetween, the two connecting wires 45A and 45B can be kept insulated from each other. This makes it possible to prevent a short circuit problem in the angle sensor 1.

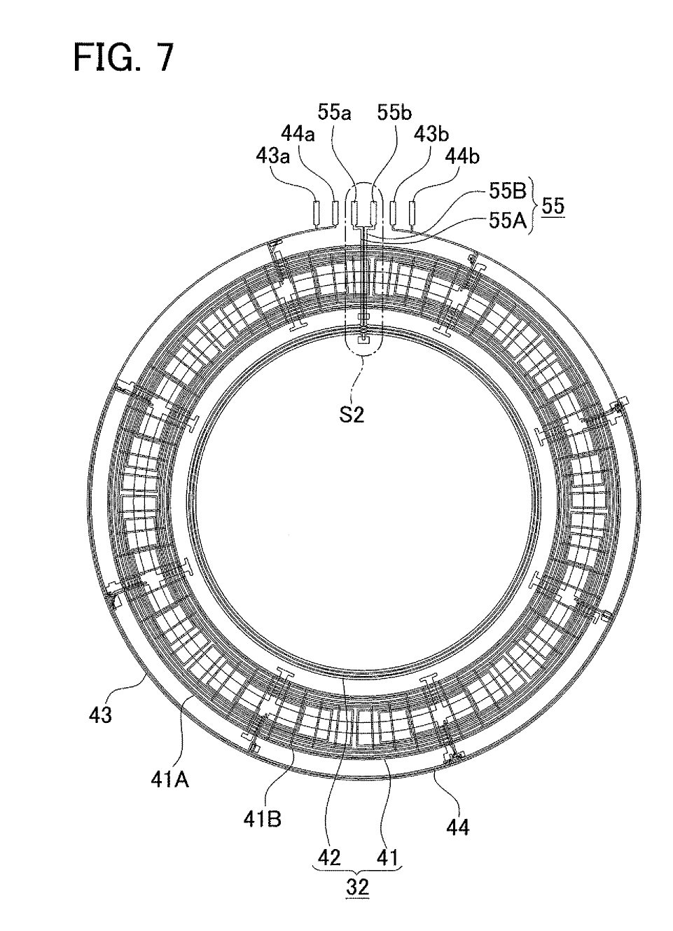

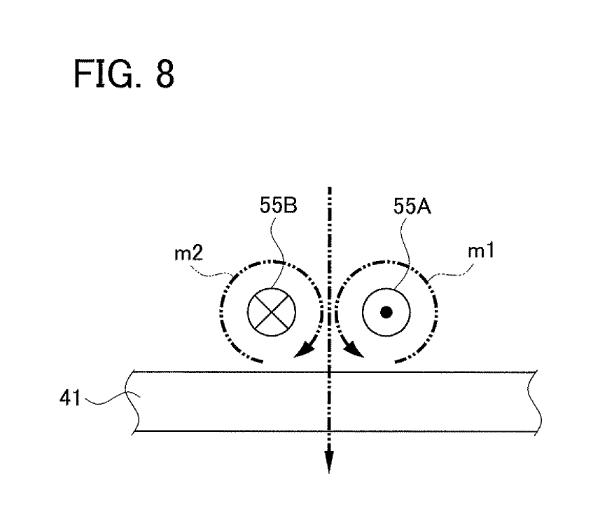

FIG. 7 is a plan view showing a planar coil 32 of a sensor stator 6 in a comparative example of the present embodiment. As shown in an elliptic area S2 surrounded by a chain line in FIG. 7, a connecting wire 55 of a rotary transformer coil pattern 42 includes two connecting wires 55A and 55B arranged to extend across or traverse a detection coil pattern 41 (a SIN phase coil pattern 41A and a COS phase coil pattern 41B). Those two connecting wires 55A and 55B are placed right and left in parallel. In this configuration of the comparative example, as shown in FIG. 8, the currents flowing in the two connecting wires 55A and 55B are opposite in direction from each other, so that magnetic fields m1 and m2 generated respectively around the two connecting wires 55A and 55B are opposite in direction from each other. Accordingly, the magnetic fields m1 and m2 reinforce each other between the two connecting wires 55A and 55B. The reinforcing direction of the magnetic fields m1 and m2 is vertical to the detection coil pattern 41. Therefore, the detection coil pattern 41 is much influenced by the magnetic linkage. This may increase detection errors in the angle sensor of the comparative example. In the present embodiment, in contrast, the influence of the magnetic linkage between the detection coil pattern 41 and the two connecting wires 45A and 45B is decreased. This can reduce the detection errors of the angle sensor 1. FIG. 8 is a schematic diagram showing a relationship between the two connecting wires 55A and 55B, their magnetic fields m1 and m2, and the detection coil pattern 41.

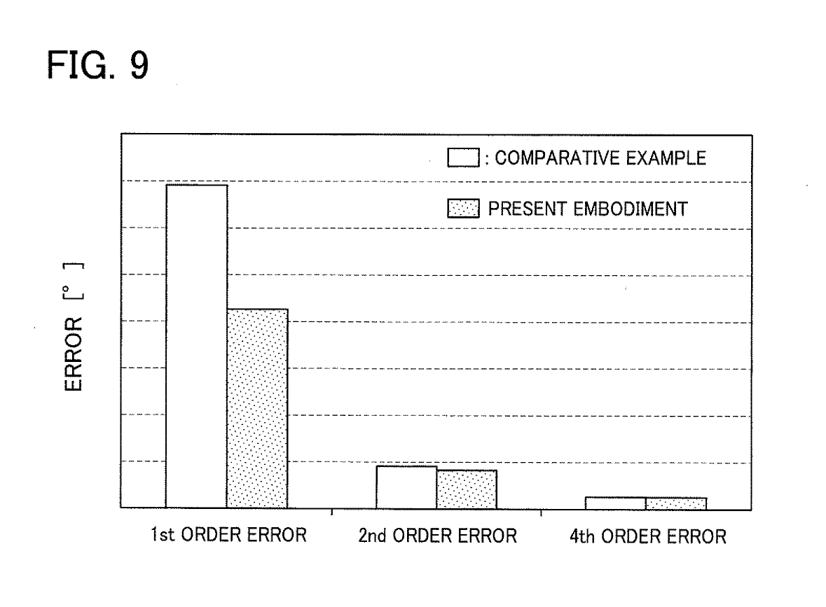

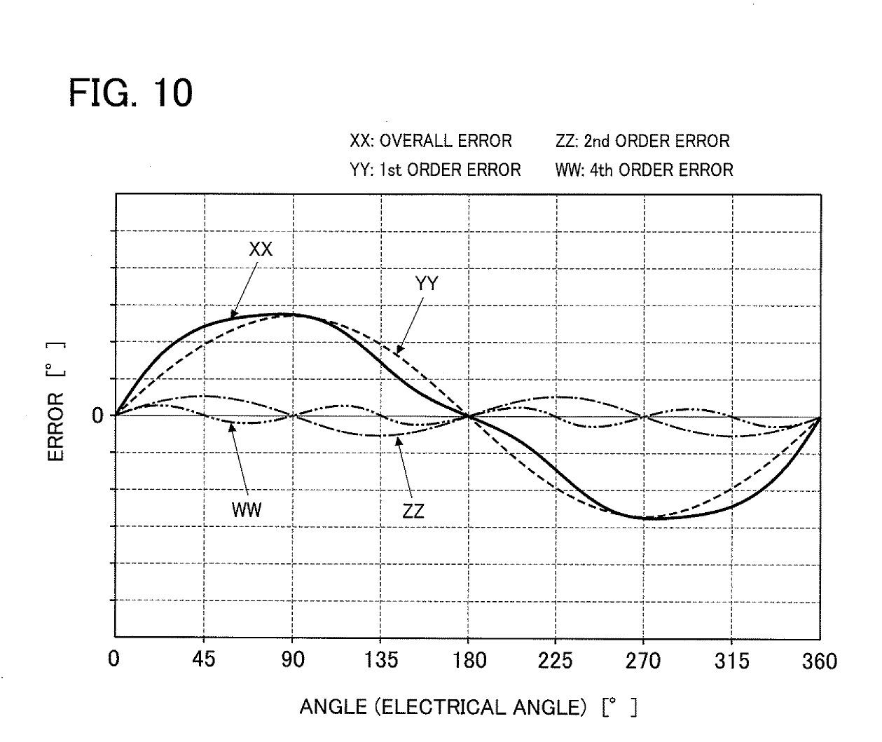

FIG. 9 is a graph showing differences in error between the present embodiment and the comparative example. As is clear from FIG. 9, regarding the second-order error and the fourth-order error, there is little difference between the present embodiment and the comparative example. In contrast, regarding the first-order error, it is found that the errors in the present embodiment are reduced to about 60% of the errors in the comparative example. Herein, FIG. 10 is a graph showing a relationship among the first-order error, second-order error, fourth-order error, and overall error. The first-order error represents a periodic error in cycles of an electric angle of 360°, the second-order error represents a periodic error in cycles of an electric angle of 180°, and the fourth-order error represents a periodic error in cycles of an electric angle of 90°, respectively.

The present invention is not limited to the aforementioned embodiment and may be embodied in other specific forms without departing from the essential characteristics thereof.

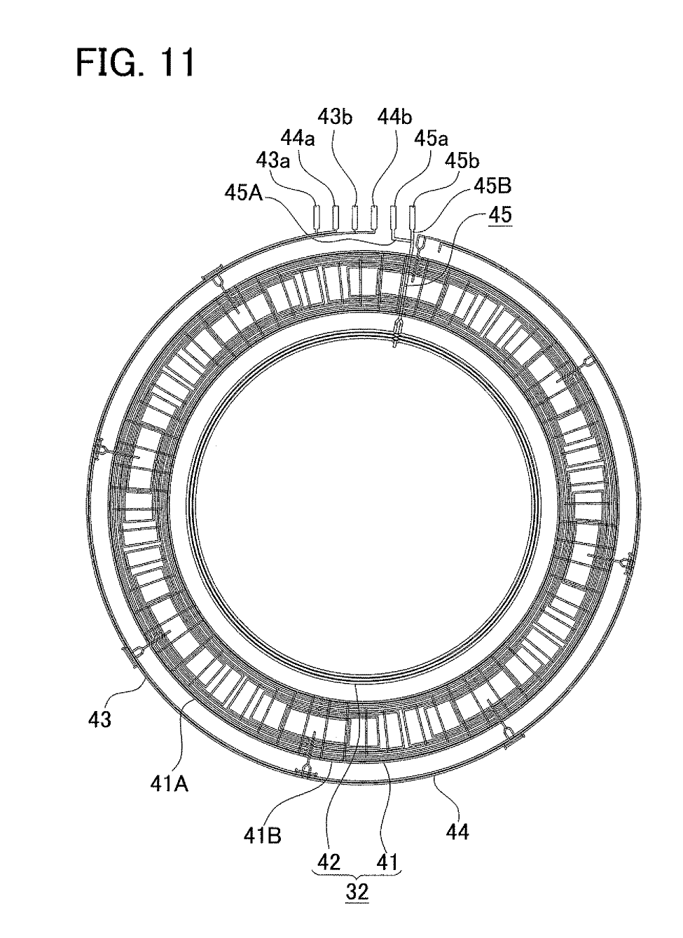

In the above embodiment, for example, the two connecting wires 45A and 45B of the rotary transformer coil pattern 42 are placed between and along the end portions of the connecting wires 43 and 44 of the detection coil pattern 41 as shown in FIG. 4. As an alternative, as shown in FIG. 11, the two connecting wires 45A and 45B of the rotary transformer coil pattern 42 may be placed along one side of an endmost one of the end portions of the connecting wires 43 and 44 of the detection coil pattern 41.

Specifically, in the above embodiment, as shown in FIG. 4, the connecting wire 43 is placed around the outer circumference of the SIN phase coil pattern 41A and provided, at both ends, with the pair of terminals 43a and 43b. The connecting wire 44 is placed around the outer circumference of the COS phase coil pattern 41B and provided, at both ends, with the pair of terminals 44a and 44b. Those terminals 43a, 43b, 44a, and 44b are arranged outside the outer circumferences of the SIN phase coil pattern 41A and the COS phase coil pattern 41B to extend in parallel to each other in their radial direction. Furthermore, the two connecting wires 45A and 45B of the rotary transformer coil pattern 42 are arranged between the pair of terminals 43a and 43b and the pair of terminals 44a and 44b which are arranged in parallel to each other, the connecting wires 45A and 45B being extended in the radial direction of the SIN phase coil pattern 41 A and the COS phase coil pattern 41B. On the other hand, as shown in FIG. 11, the two connecting wires 45A and 45B of the rotary transformer coil pattern 42 may be arranged at one side of an endmost one (the terminal 44b in this example) of all the terminals 43a, 43b, 44a, and 44b arranged in parallel, the connecting wires 45A and 45B being extended in the radial direction of the SIN phase coil pattern 41A and the COS phase coil pattern 41B.

In the above embodiment, the two connecting wires 45A and 45B of the rotary transformer coil pattern 42 are placed to overlap one above the other over their entire length. As an alternative, the two connecting wires may be placed so that only their portions traversing across the SIN phase coil and the COS phase coil overlap one above the other.

While the presently preferred embodiment of the present invention has been shown and described, it is to be understood that this disclosure is for the purpose of illustration and that various changes and modifications may be made without departing from the scope of the invention as set forth in the appended claims.

### INDUSTRIAL APPLICABILITY

The present invention is utilizable for detection of rotation angle of a motor and an engine.

What is claimed is:

1. An angle sensor including:
a sensor rotor having a main surface formed with a planar coil, the sensor rotor being attached to a rotary shaft and; and
a sensor stator having a main surface formed with a planar coil, the sensor stator being placed so that its main surface faces the main surface of the sensor rotor with a gap therefrom,
the planar coil of the sensor stator including an SIN phase coil and a COS phase coil each having an annular ring shape, and a rotary transformer coil placed radially inside of a region where the SIN phase coil and the COS phase coil are provided,
the rotary transformer coil including two connecting wires to be connected to an external circuit, the two connecting wires being placed to extend across the SIN phase coil and the COS phase coil,
wherein the two connecting wires of the rotary transformer coil are placed so that at least portions extending across the SIN phase coil and the COS phase coil overlap one above the other.

2. The angle sensor according to claim 1, wherein the two connecting wires are placed one above the other while an insulating film is interposed therebetween.

3. The angle sensor according to claim 2, wherein
the SIN phase coil includes a connecting wire placed on an outer circumference and a pair of terminals provided at both ends of the connecting wire,
the COS phase coil includes a connecting wire placed an outer circumference and a pair of terminals provided at both ends of the connecting wire,
the pair of terminals of the SIN phase coil and the pair of terminals of the COS phase coil are arranged outside the outer circumferences of the SIN phase coil and the COS phase coil and in parallel to each other to extend in a radial direction of the coils, and
the two connecting wires of the rotary transformer coil are placed between the pair of terminals of the SIN phase coil and the pair of terminals of the COS phase coil arranged in parallel to each other, the connecting wires of the rotary transformer coil being extended in the radial direction of the SIN phase coil and the COS phase coil.

4. The angle sensor according to claim 2, wherein
the SIN phase coil includes a connecting wire placed on an outer circumference and a pair of terminals provided at both ends of the connecting wire,
the COS phase coil includes a connecting wire placed an outer circumference and a pair of terminals provided at both ends of the connecting wire,
the pair of terminals of the SIN phase coil and the pair of terminals of the COS phase coil are arranged outside the outer circumferences of the SIN phase coil and the COS phase coil and in parallel to each other to extend in a radial direction of the coils, and
the two connecting wires of the rotary transformer coil are placed at one side of an endmost one of all the terminals arranged in parallel, the connecting wires of the rotary transformer coil being extended in the radial direction of the SIN phase coil and the COS phase coil.
